(19) United States
(12) Patent Application Publication
(10) Pub. No.: US 2006/0235902 A1
(43) Pub. Date: Oct. 19, 2006

(54) Method for preserving access to deleted and overwritten documents

(76) Inventor: Rajesh Kapur, Scarborough (CA)

Correspondence Address: Mr. Rajesh Kapur, 264 Huntsmill Boulevard, Scarborough, ON, M1W 3G6, CA

(21) Appl. No.: 11/157,935

(22) Filed: Jun. 22, 2005

(30) Foreign Application Priority Data
Apr. 14, 2005 (CA) 2,504,070

(51) Int. Cl. G06F 17/30

(52) U.S. Cl. 707/202

(57) ABSTRACT

A method for preserving access to deleted or overwritten document data within a system, wherein said document data is stored in a system filestore associated with a system database containing reference data to point to the document data within the system filestore, the method comprising the steps of: determining that a delete/overwrite command has been issued; recording the reference data prior to, or after the deleting or updating of the reference data; inserting the recorded reference data in a set of access-preservation tables; and providing the set of access-preservation tables to point to the deleted/overwritten document data within the filestore.

### BACKGROUND OF THE INVENTION

Many large companies use document management software. The purpose of such software is to help companies keep track of large volumes of documents in an organized way, so that documents can be easily stored, found and retrieved. In many cases, there will be more than one version of a particular document. Thus, version control is another aspect of most document management systems. Version control is an issue of particular importance in situations where different people are able to share documents and have shared access to the documents, including a shared right to independently modify the documents.

One example of a company in which a document management software system would be useful is an engineering company that has many versions of the same part. When a client orders that part the company has to find the correct part version.

The document management system typically includes a system database that is associated with a filestore. The filestore stores the actual document data, while the system database stores reference information that points to the document within the filestore. Also, the system database typically stores supplementary document information regarding each document.

As part of the management of documents, documents get deleted from the filestore, or a particular version of the document gets overwritten by a new version. However, in some cases, the deleting or overwriting gets done in error, with valuable information within the document, or the previous version thereof, being lost in the process. When this happens, it is desirable for the user to be able to get his original document back. However, often, by the time the user realises that he needs his original document back, the document management system has run a standard clean-up routine that makes it effectively impossible to retrieve the deleted or overwritten file. Clean up routines are required because if the system database is not cleaned up every so often to account for deletion and overwriting of documents, inconsistencies can arise in, the system database information, which can eventually lead to corruption of the filestore.

Documentum™ is a document management system that comprises of three different layers (or technologies) sitting on top of an operating system (server based) such as Unix or Windows 2000 server, a system database, and a filestore.

The layers comprise of a Documentum application server layer that sits on top of the database and serves Documentum client interfaces. The reference information (i.e. the information pointing to the physical document data) and supplementary document information (i.e. the attributes of the types of Documents stored) are stored in the database. The actual physical data is stored in a filestore on either the server, a Storage area network (SAN) or Filer pointed to by the server.

### SUMMARY OF THE INVENTION

What is required is a method for allowing users to retrieve deleted and/or overwritten documents being managed by a document management system.

Accordingly, there is provided a method for preserving access to deleted or overwritten document data within a system, wherein said document data is stored in a system filestore associated with a system database containing reference data to point to the document data within the system filestore, the method comprising the steps of,
determining that a delete/overwrite command has been issued;
recording the reference data prior to the deleting or updating of the reference data;
inserting the recorded reference data in a set of access-preservation tables; and
providing the set of access-preservation tables to point to the deleted/overwritten document data within the filestore.

Preferably, the reference data is contained within three system tables in the system database, and wherein the recording step comprises the step of recording reference data from said three system tables. Preferably, the system, in response to a delete/overwrite command, deletes reference data from first and second system tables and updates reference data from a third system table. Preferably, the system comprises a Documentum document management system, and wherein the first system table comprises a dm_sysobject_s table, the second system table comprises a dm_sysobject_r table, and the third table comprises a dmr_content_r table. Preferably, the reference data comprises object identification data from the first table, version identification data from the second table, and a parent identification within the third table, wherein the parent identification can be joined to a fourth table which points to the document data in the system filestore. Preferably, the system comprises a Documentum document management system and wherein the fourth table comprises a dmr_content_s table. Preferably, the recording step comprises recording the reference data using at least one Oracle trigger. Preferably, the recording step comprises recording the reference data using a first Oracle trigger associated with the first table, a second Oracle trigger associated with the second table, and a third Oracle trigger associated with the third table. Preferably, the set comprises a first access-preservation table to receive reference data recorded from the first system table, a second access-preservation table to receive reference data recorded from the second system table, and a third access preservation table to receive reference data recorded from the third system table. Preferably, the method further comprises the step of using the reference data from the access preservation data to obtain supplementary document information, related to the deleted/overwritten document, from system tables. Preferably, the supplementary document information includes information selected from the following group: a name of the document deleted or overwritten, a folder within the system database from the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date that the document was deleted/overwritten. Preferably, the method further comprises combining the access-preservation table and the supplementary document information into a combined table. Preferably, the combining step comprises combining prior to the system executing a method that cleans the system tables to prevent access to supplementary document information for deleted/overwritten documents from the system tables. Preferably, the system comprises a Documentum document management system, and wherein the method is carried out by a dm_clean routine. Preferably, the recording, inserting and providing steps are executed by the execution of Oracle software code. Preferably, the recording, inserting and providing steps are executed by the execution of SQL Server software code.

### DETAILED DESCRIPTION

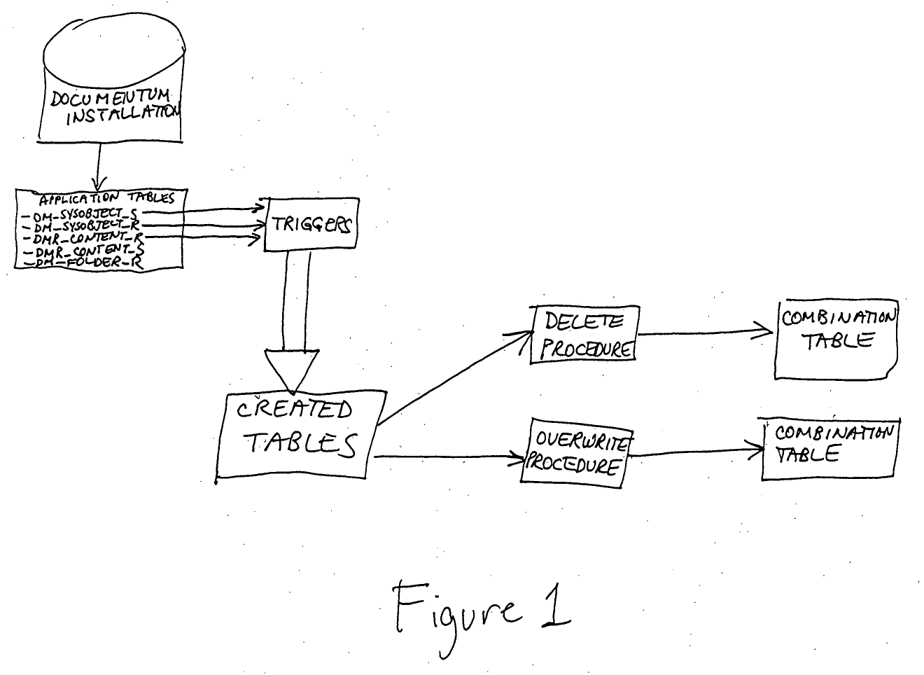

FIG. 1 shows a The preferred form of the invention allows the capture of relevant reference and supplementary document information at the exact time it is deleted or updated by means of Oracle database triggers. These triggers are added to the relevant Documentum tables and they automatically fire to capture the salient information needed to retrieve the pointer information to the physical data for the file by running a couple of stored procedures.

A typical Documentum system database has a number of system tables that store reference information and supplementary document information. These tables include (but are not typically limited to) the dm_sysobject_s table (first table), which stores object IDs for the documents; the dm_sysobject_r table (second table) which stores, inter alia, version IDs for documents; the dmr_content_r table (third table) which stores, inter alia, parent ID needed to find the pointer to the document within the filestore; and the dmr_content_s table (fourth table), which stores an r_object_ID that, together with the parent_ID, determines the pointer to the location of the document within the filestore.

When a document is deleted/overwritten, the relevant reference data from the first two tables is deleted, and the relevant reference data from the third table (including the parent ID) is updated to a Null.

According to the invention, at least one, and preferably three, Oracle triggers are used to catch and record the reference data that was deleted and/or updated. These reference data are then inserted into access-preservation tables (preferably one corresponding to each of the first three system tables), and the access-preservation data are provided to point to the deleted/overwritten document within the filestore.

In the preferred method, the reference data from the access preservation tables is used to obtain supplementary document information, related to the deleted/overwritten document, from the system tables (preferably the first, second and third ones). The supplementary document information preferably includes a name of the document deleted or overwritten, a folder within the system database from which the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date that the document was deleted/overwritten.

The method preferably further comprises the step of combining the access preservation tables and the supplementary document information into a set of at least one combined table. This step is preferably performed before the system executes a cleaning of the system tables, because at least some of the supplementary document information will not be available once a cleaning, such as a dm_clean routine, is run.

In typical operation, the data location within the filestore at which a document is located is obtained by combining the parent ID from the third table with the r_object_ID from the fourth table to obtain the data ticket (i.e. the pointer) along with the storage ID which can be used to find the file path of the document on the filestore.

This pointer information can then be translated through commonly available Documentumsupport notes. The Data Ticket and the storage_id (pointer info) are two pieces of data that need to be obtained to help retrieve the document's physical file. The other information required is the r_object_id and the parent_id.

The actual path and filename are typically encrypted within the filestore to protect the document from unauthorized access. To decrypt, support note 310 is used and the parent_id taken from the combination tables described further below; before dm_clean is run, the parent ID is plugged into the Documentum APIs shown on the note through the API interface in Documentum Administrator.

For example:

apply,c, 090106d450cgbs3b, GET_PATH
next,c,q0
get,c,q0,result

This should give you the path of the file on the content store (but only works before dm_clean is run).

As described below, another Documentum support note can also be used to calculate the full file path and name of the document stored on the server. This is done using the r_object_id storage_id and Data_ticket (all values contained in the combination tables This alternate calculation of the file path and name can be compared with the above calculation using note 310 to increase the probability that the correct file path and name are known. Once dm_clean has been run, the note 310 calculation will not work, but the alternate calculation will function to find the exact place on the server or backup tape at which a deleted file resides. The method of the present invention can then be used from the time of successful comparison of the two name and path calculations. i.e. by running the procedures below automatically through either a Cron/or Veritas job.

When an object or document is deleted or overwritten, the parent_id of the document is updated and set to Null. Once this occurs there is no way to link the dmr_content_r table to the dmr_content_s table. The purpose of the recording of reference information was, inter alia, to ensure that the parent ID was recorded in order to get storage location and data ticket.

Below, there is shown sample code implementing this portion of the invention. Code is given for both Oracle and SQL Server (For Delete is for older versions). The invention can be implemented in a multi-database embodiment.

Oracle

create or replace trigger capture_del_s_trigger
before delete on dm_sysobject_s
for each row
Begin
kapurture_del_s(:old.r_object_id,:old.r_object_type,:old.object_name);
EXCEPTION
when others then
RAISE;
END;
/
create or replace trigger capture_i_trigger
before update on dmr_content_r
for each row
Begin
kapurture_del_i(:old:r_object_id,:old.parent_id);
EXCEPTION
When others then
RAISE;
END;
/
Create or replace trigger capture_del_r_trigger
before delete on dm_sysobject_r
for each row
Begin
kapurture_del_r(:old.r_object_id,:old.r_version_label,:old.i_folder_id);
EXCEPTION
when others then
RAISE;
END;
/
then Sql Server:-
create trigger capture_del_r_trigger
on dbo.dm_sysobject_r
After Delete -- FOR Delete
as
if exists ( insert into capture_del_r_table values (r_object_id, r_version_label, i_folder_id)
select r_object_id, r_version_label, i_folder_id from deleted where
r_object_id in (select r_object_id from deleted)
)
go
create trigger capture_i_trigger
on dbo.dmr_content_r
After Update -- FOR Update
as
if exists ( insert into capture_i_table values (r_object_id, parent_id)
select r_object_id, parent_id from deleted where
r_object_id in (select r_object_id from deleted)
)
go
create trigger capture_del_s_trigger
on dbo.dm_sysobject_s
After Delete -- FOR Delete
as
if exists ( insert into capture del_s_table values (r_object_id, r_object_type,
object_name,date_saved)
select r_object_id, r_object_type, object_name,getdate( ) from deleted where
r_object_id in (select r_object_id from deleted)
)
go

In the the dm_sysobject_s and dm_sysobject_r tables, a “before row delete” is preferably used, meaning the data the is about to be deleted is captured. For the dmr_content_r table, a “before update row” is preferably used, meaning that the data to be updated is captured. This ensures that all salient and/or relevant information is captured.

It will be appreciated that an “after row delete” and “after row update” could also be used and are comprehended by the invention. In such a case, the old values are captured immediately upon the deletion or update.

The reference data is trapped (i.e. recorded) and inserted into three tables:

create table capture_i_table (
r_object_id varchar2(16),
parent_id varchar2(32),
date_saved date)
/
create table capture_del_s_table (
r_object_id varchar2(16),
r_object_type varchar2(32),
object_name varchar2(255),
date_saved date)
/
create table capture_del_r_table (
r_object_id varchar2(16),
r_version_label varchar2(32),
i_folder_id varchar2(16))
/

More columns for extra data can of course be added to these tables, but the preferred method comprises recording the salient reference data from three tables.

The procedures, given the names R_Kapurture_del_data.plb and R_Kapurture_upd_data.plb, then are used to combine the three access-preservation tables with the dmr_content_s table to produce the combination tables and to get the all important data_ticket value which must be converted to a char using to_char(data_ticket) as well as combining other data.

The combination tables could take the form of a single table for both deletes and overwrites. However, it is preferred that there be a combination table for deletes and one for overwrites.

create table capture_del_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/
create table capture_upd_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/

Once the storage_id, data_ticket, r_object_d, parent_id are available in the above tables the method of the present invention is preferably every night and just before dm_clean runs. This will ensure that all of the necessary reference data is captured.

The following is the “alternate” process referred to above for calculating the file path and name. Take the storage_id obtained and use it as the r_object_id into the table dm_store_s. This should give you the filestore concerned (there could be more than one filestore, which collectively act as the “filestore” for the document management system. The path of the filestore can be found through the Documentum administrator Part of the file path on the filestore is stored as a hex code. The first part of this hex code is usually contained within the r_object_id of the deleted row corresponding to the deleted document. The remainder of the filepath can be obtained by converting the data_ticket from dec to hex using the dword function on the standard scientific calculator on Microsoft windows, as the support notes will indicate.

For example if you have a data ticket say −2147561899 this converts into 75FECE55 . . . i.e the path to the file could look something like this c:\filestore1\documentum\docbase_name\00\06d450\75\FE\CE\55 where 55 is the file name On the server and 0006d450 comes from the r_object_id.

Once the formula for the file paths has been worked out by comparing with the above API method then a plsq1 routine could even be written to give this automatically.

Basically once the path is known and the date is known, the document that was deleted or overwritten can be retrieved from a Backup tape if it has been cleaned off the server. This is because the path and name are known, so the tape copy of the filestore can be used to locate the deleted/overwritten file.

As Iam providing a working prototype of this tool I should give some instructions on installation and execution.

The preferred mode of installation and execution of the method is as follows. Proceed to the sql prompt of your respective database and the docbase user account.

Once you have done this by the command “sqlplus username/password” you should be at the sql prompt you can first add the tables.

sql>(cre tables.sql

then add the following .plb procedures.

sql>@kapurture_del_i.plb
sql>@kapurture_del_r.plb
sql>@kapurture_del_s.plb

after which add the three triggers
sql>gtrigger.sql

and then the two procedures R_kapurture_del_data.plb and R_kapurture_upd_data.plb as so

sql>@R_kapurture_del_data.plb
sql>@R_kapurture_upd_data.plb

all you then need to do as everything else is automatic is

sql>exec R_kapurture_del_data
sql>exec R_Kapurture_upd_data

As described above, these procedures should be run before the dm_clean routine is run, and preferably each night.

1-16. (canceled)

17. A method for preserving access to versions of deleted and or overwritten document data from a system, allowing the identification of type of delete command being issued, where said type of delete command being issued is either a delete or an overwritten delete, and furthermore the capture of the document data based or document version and said type of delete command at the time and date of recording allowing physical separation of the document data and retrieval of a document in the event said document or the document data was deleted or overwritten in error, wherein said document is stored in a system filestore associated with a system database that contains said document data which consists of reference data to point to documents within the system filestore, and supplementary data regarding the document the method comprising steps of:
(a) determining that the delete or overwrite command has been issued; and
(b) recording the reference data with identification information after the delete command or overwritten delete command is issued but at the time and date prior to or after the deleting or updating of the reference data by means of at least one database trigger initiated by the delete or overwrite command;
(c) inserting the recorded reference data into at least one newly coded access preservation record or table; and
(d) combining and separating document data using the identification information including date and time information stored in the said reference date within the at least one access preservation table together with the supplementary data consisting of any remaining reference data and document data still residing within the system before it is cleaned from the system, using at least one procedure to do the combining and separating in regards to the deleted and or overwritten document into at least one combination table; and
(e) providing the at least one combination table to preserve document data to point to the deleted documents, and overwritten documents within the system filestore; and
(f) retrieving the deleted and or overwritten document version or versions on user request by using time and date information from within the at least one combination table.

18. A method as claimed in claim 17, wherein the reference data prior to deletion is contained in system tables in the system database, and wherein the recording step comprises the step of recording reference data from said system tables.

19. A method as claimed in claim 18 wherein the system in response to a delete and or overwrite command deletes or updates reference data from the system tables.

20. A method as claimed in claim 19 wherein the reference data to the recorded from the system tables comprises the step of determining, identifying and recording the reference data to the at least one access preservation table added to the system database using actions stored within the at least one database trigger added to at least one of the system tables within the system database that fires when a delete or overwrite transaction occurs.

21. A method as claimed in any one of the claims 17 to 20, comprising the at least one procedure added to the system database further comprising instruction to combine the object, transaction type, version and document identification in the reference data recorded, together with a date and time into a unique reference to identify the deleted or overwritten document in the filestore and store in the least one combination table.

22. A method as claimed in any one of the claims 17 to 21 comprising retrieval of the deleted and or overwritten documents in regards to their version or versions on user request using the unique reference from within the at least one combination table.

23. A system for preserving access to versions of deleted or overwritten document information comprising:
(a) a database for storing document information consisting of reference information to point to a document in a filestore and document information; and
(b) at least one trigger containing at least one procedure for catching and recording, identifying, deleted and overwritten reference information from at least one system table containing reference information that has been deleted and or updated from the database; and
(c) at least one access preservation table for storing the deleted and overwritten reference information, the access preservation data being operable to point to the data that has been deleted and/or updated; and
(d) at least one database procedure to combine and separate reference information from the at least one access preservation table and supplementary document information comprising the reference and the document information still within the database before it is cleaned into at least one combination table.

24. A system according to claim 23 further comprising the at least one system table provided in the database for storing the reference information and document information.

25. A system according to claim 23 wherein the at least one access preservation table corresponds to the at least one system table.

26. A system according to any one of claims 23 to 25 further comprising storage identification means for indicating position of storage within the filestore.

27. A system according to any one of claims 23 to 26 further comprising object identification means.

28. A system according to any one of claims 23 to 27 further comprising the at least one combination table.

29. A system according to claim 28 further comprising a data combination means or the at least one database procedure operable to combine the at least one access preservation table and the supplementary document information from the system into the at least one combination table.

30. A system according to claim 28 or claim 29 wherein the at least one combination table comprises deleted data.

31. A system according to claim 28 or claim 29 wherein the at least one combination table comprises updated/overwritten data.

32. A system according to claim 28 or claim 29 wherein the at least one combination table comprises deleted data and updated/overwritten data.

33. A system to preserve deleted and overwritten documents that can be attached to a documentation management system having a filestore, and a system database the system comprising:
(a) at least one system table, and at least one access preservation table; and
(b) at least one database trigger to catch, identify, classify and record using actions or database procedures contained within said database trigger, the delete I and or overwritten transactions on the at least one system table in order to store in the least one access preservation table; and
(c) at least one database procedure to combine and separate the supplementary data in the system table and reference data in the at least one access preservation table in order to identify the deleted overwritten document or versions of in the filestore storing said data into at least one combination table; and
(d) retrieving the deleted and or overwritten document versions or version on user request by retrieving and using relevant information from the at lens; one combination table.

34. A document management system containing the system to preserve deleted and overwritten documents as claimed in claim 33.
